(19) United States
(12) Patent Application Publication
(10) Pub. No.: US 2022/0327944 A1
(43) Pub. Date: Oct. 13, 2022

(54) SENSORY EDUCATIONAL ASSEMBLY INCLUDING EXPANDABLE AND COLLAPSIBLE BUTTON ASSEMBLIES

(71) Applicant: Task-Tiles LLC, Stow, OH (US)

(72) Inventors: Taryn Bukowski, Stow, OH (US); Kortney Lindsey, Stow, OH (US)

(73) Assignee: Task-Tiles LLC, Stow, OH (US)

(21) Appl. No.: 17/228,845

(22) Filed: Apr. 13, 2021

(51) Int. Cl. G09B 1/06; G09B 19/00

(52) U.S. Cl. CPC G09B 1/06; G09B 19/00

(57) ABSTRACT

A sensory educational assembly includes a storage assembly; an identification assembly carried by the storage assembly and including a plurality of expandable and collapsible button assemblies capable of extending from a first collapsed position to a second expanded position; the expandable and collapsible button assemblies of the plurality of expandable and collapsible button assemblies including a releasable fastener on a top surface thereof; and a plurality of identification icons having a respective releasable fastener on a bottom surface thereof; such that the plurality of identification icons having the respective releasable fastener are capable of fastening with the releasable fasteners of the expandable and collapsible button assemblies to thereby provide the expandable and collapsible button assemblies with the plurality of identification icons in an in-use configuration of the sensory educational assembly.

### FIELD OF THE INVENTION

The present invention relates to sensory educational assembly including expandable and collapsible button assemblies. The expandable and collapsible button assemblies can be provided with a variety of identification icons such that a user of the sensory educational assembly can demonstrate recognition of a certain identification icon by expanding or collapsing the respective button.

### BACKGROUND OF THE INVENTION

Students, especially those diagnosed with Autism Spectrum Disorders, can have highly specific sensory input needs. Oftentimes, those sensory input needs can interfere with the learning process.

U.S. Pat. No. 10,170,012 discloses a communication system and method provided to assist a user in conveying or exchanging a communication. The communication system includes a portable communication book with a landing pad configured to receive a communication card removably attachable thereto. The communication card may include a hold and release type fastener on both surfaces where one surface may be used to removably attach the communication card to the landing pad and the other surface may receive icon pieces. The icon pieces may form a sentence or message.

U.S. Pat. No. 7,140,643 discloses an apparatus for teaching early learning skills. The apparatus includes a book binder and a plurality of removable pages. Each of the pages has a mounting surface or mounting locations for releasably attaching a plurality of symbol devices formed as letters or numbers.

There remains a need in the art for an improved sensory educational assembly.

### SUMMARY OF THE INVENTION

In a first embodiment, the present invention provides a sensory educational assembly comprising a storage assembly; an identification assembly carried by the storage assembly and including a plurality of expandable and collapsible button assemblies capable of extending from a first collapsed position to a second expanded position; the expandable and collapsible button assemblies of the plurality of expandable and collapsible button assemblies including a releasable fastener on a top surface thereof; and a plurality of identification icons having a respective releasable fastener on a bottom surface thereof; such that the plurality of identification icons having the respective releasable fastener are capable of fastening with the releasable fasteners of the expandable and collapsible button assemblies to thereby provide the expandable and collapsible button assemblies with the plurality of identification icons in an in-use configuration of the sensory educational assembly.

In a second embodiment, the present invention provides a sensory educational assembly as in any of the above embodiments, wherein the storage assembly is a ring binder having a front cover providing a front inner surface and a back cover providing a back inner surface.

In a third embodiment, the present invention provides a sensory educational assembly as in any of the above embodiments, wherein the identification assembly is positioned on the front inner surface.

In a fourth embodiment, the present invention provides a sensory educational assembly as in any of the above embodiments, wherein the identification assembly is positioned on only the front inner surface such that the back inner surface is devoid of an identification assembly.

In a fifth embodiment, the present invention provides a sensory educational assembly as in any of the above embodiments, wherein a second identification assembly is positioned on the back inner surface.

In a sixth embodiment, the present invention provides a sensory educational assembly as in any of the above embodiments, wherein the plurality of expandable and collapsible button assemblies are arranged in a grid-type arrangement.

In a seventh embodiment, the present invention provides a sensory educational assembly as in any of the above embodiments, wherein all of the plurality of expandable and collapsible button assemblies are spaced equidistant from each other relative to a nearest respective one of the plurality of expandable and collapsible button assemblies.

In an eighth embodiment, the present invention provides a sensory educational assembly as in any of the above embodiments, wherein the plurality of expandable and collapsible button assemblies are arranged in a honeycomb-type arrangement.

In a ninth embodiment, the present invention provides a sensory educational assembly as in any of the above embodiments, wherein the plurality of identification icons include a plurality of colors.

In a tenth embodiment, the present invention provides a sensory educational assembly as in any of the above embodiments, wherein the plurality of identification icons include a plurality of letters.

In an eleventh embodiment, the present invention provides a sensory educational assembly as in any of the above embodiments, each of the plurality of expandable and collapsible button assemblies including an extendable component coupled with a base.

In a twelfth embodiment, the present invention provides a sensory educational assembly as in any of the above embodiments, wherein the extendable component carries a button defining the top surface, the button positioned at an end of the extendable component opposing the base.

In a thirteenth embodiment, the present invention provides a sensory educational assembly as in any of the above embodiments, wherein a diameter of the button approximates a diameter of the base.

In a fourteenth embodiment, the present invention provides a sensory educational assembly as in any of the above embodiments, wherein the extendable component is snap-fit with the base.

In a fifteenth embodiment, the present invention provides a sensory educational assembly kit comprising a storage assembly; an identification assembly carried by the storage assembly and including a plurality of expandable and collapsible button assemblies capable of extending from a first collapsed position to a second expanded position; the expandable and collapsible button assemblies of the plurality of expandable and collapsible button assemblies including a releasable fastener on a top surface thereof; an overall storage bag including a first sub-storage assembly with a first plurality of identification icons having a respective first releasable fastener on a bottom surface thereof; a second sub-storage assembly with a second plurality of identification icons having a respective second releasable fastener on a bottom surface thereof; such that the first plurality of identification icons having the respective first releasable fastener and the second plurality of identification icons having the respective second releasable fastener are capable of fastening with the releasable fasteners of the expandable and collapsible button assemblies to thereby provide the expandable and collapsible button assemblies with the plurality of identification icons in an in-use configuration of the sensory educational assembly.

In a sixteenth embodiment, the present invention provides a sensory educational assembly kit as in any of the above embodiments, wherein the storage assembly is a ring binder having a front cover providing a front inner surface and a back cover providing a back inner surface, wherein the identification assembly is positioned on the front inner surface.

In a seventeenth embodiment, the present invention provides a sensory educational assembly kit as in any of the above embodiments, wherein the first plurality of identification icons include a plurality of colors, and wherein the second plurality of identification icons include a plurality of letters.

In an eighteenth embodiment, the present invention provides a sensory educational assembly comprising a storage assembly; an identification assembly carried by the storage assembly and including a plurality of expandable and collapsible button assemblies capable of extending from a first collapsed position to a second expanded position; the expandable and collapsible button assemblies of the plurality of expandable and collapsible button assemblies including a releasable fastener on a top surface thereof; a plurality of identification icons having a respective releasable fastener on a bottom surface thereof; the plurality of identification icons being fastened with respective ones of the plurality of expandable and collapsible button assemblies; wherein at least one of the plurality of expandable and collapsible button assemblies is in the first collapsed position, and wherein at least one of the plurality of expandable and collapsible button assemblies is in the second expanded position.

In a nineteenth embodiment, the present invention provides a sensory educational assembly as in any of the above embodiments, wherein the storage assembly is a ring binder having a front cover providing a front inner surface and a back cover providing a back inner surface, wherein the identification assembly is positioned on the front inner surface.

In a twentieth embodiment, the present invention provides a sensory educational assembly as in any of the above embodiments, each of the plurality of expandable and collapsible button assemblies including an extendable component coupled with a base, wherein the extendable component carries a button defining the top surface, the button positioned at an end of the extendable component opposing the base, wherein the extendable component is snap-fit with the base.

### BRIEF DESCRIPTION OF THE DRAWINGS

Advantages of the present invention will become better understood with regard to the following description, appended claims, and accompanying drawings wherein:

FIG. 1 is a perspective view of a sensory educational assembly according to one or more embodiments of the present invention, shown with the expandable buttons in a grid-type arrangement;

FIG. 2 is an alternative perspective view of the sensory educational assembly shown in FIG. 1, and showing icon storage assemblies;

FIG. 3 is a perspective, sectional view of an identification assembly of the sensory educational assembly shown in FIG. 1, shown with certain expandable buttons in the expanded position;

FIG. 4 is a perspective view of the identification assembly shown in FIG. 1, shown with certain expandable buttons including identification icons;

FIG. 5 is a perspective view of the identification assembly shown in FIG. 4, shown with one of the expandable buttons including an identification icon in the expanded position;

FIG. 6 is a perspective view of the identification assembly shown in FIG. 1, shown with certain expandable buttons including alternative identification icons, and shown with the expandable buttons in an alternate honeycomb-type arrangement;

FIG. 7 is a perspective view of the icon storage assemblies of the sensory educational assembly shown in FIG. 2;

FIG. 8 is a perspective view of one of the icon storage assemblies shown in FIG. 7, shown with the identification icons removed from a carrier; and

FIG. 9 is a schematic of a method of operating the sensory educational assembly.

### DETAILED DESCRIPTION OF ILLUSTRATIVE EMBODIMENTS

One or more embodiments of the present invention provide a sensory educational assembly. The sensory educational assembly includes an identification assembly with a plurality of expandable and collapsible button assemblies. The button assemblies are capable of carrying a variety of identification icons. Advantageously, the expandable and collapsible button assemblies, which may also be referred to as socket assemblies, in use thereof include a plurality of identification icons such that a user of the sensory educational assembly can demonstrate recognition of a certain identification icon by expanding or collapsing a respective one of the button assemblies. The sensory educational assembly may be useful for a variety of learning activities, such as academic tasks, object differentiation, task chains, macro-scheduling, micro-scheduling, sentence formation, and vocabulary.

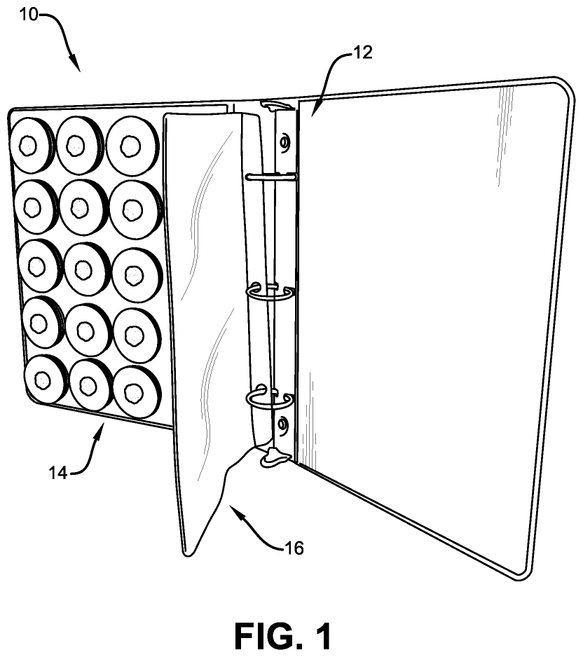

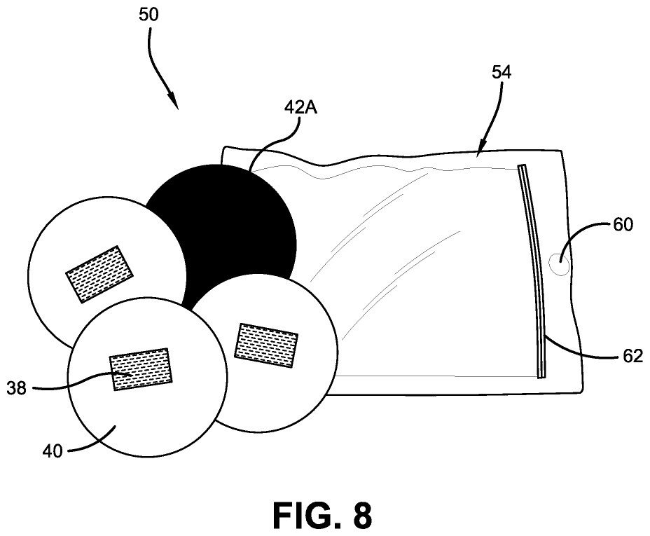

With reference to FIGS. 1-8, a sensory educational assembly according to one or more embodiments of the present invention is generally indicated by the numeral 10. Sensory educational assembly 10 includes a storage assembly 12 carrying an identification assembly 14. In one or more embodiments, as shown in FIG. 1, only one identification assembly 14 may be utilized. In other embodiments, storage assembly 12 may include two or more identification assemblies 14, for example where each inner surface of storage assembly 12 includes an identification assembly 14. Storage assembly 12 further includes an icons assembly 16, which also be referred to as a storage assembly 16, that includes the identification icons for identification assembly 14.

Storage assembly 12 may be a variety of suitable assemblies that are capable of carrying identification assembly 14. Exemplary storage assemblies 12 include ring binders and clipboards.

With reference to FIGS. 1-8, storage assembly 12 is shown as ring binder 12, which may be of any suitable size, such as 8.5 inch by 11 inch. Ring binder 12 includes a spine portion having a front cover and a back cover extending from opposite side edges thereof by way of respective hinges. Ring binder 12 further includes a ring assembly 18 that may be positioned on either the front cover, the spine portion, or the back cover. As perhaps best seen in FIGS. 1, 2, and 7, ring binder 12 includes the ring assembly 18 being positioned on the back cover. Ring assembly 18 provides rings 20. Rings 20 may be either circular shaped or D-shaped. In one or more embodiments, ring assembly 18 includes three rings 20, in other embodiments, two rings 20. In one or more embodiments, rings 20 may be about 1½ inch diameter, in other embodiments, about 1 inch diameter, in other embodiments, about ½ inch diameter.

Front cover provides an inner surface 22 and back cover provides an inner surface 24, which may also be referred to as substrates 22, 24. As shown in the Figures, only one identification assembly 14 is provided on inner surface 22, though this one identification assembly 14 may also be placed on inner surface 24. In other embodiments, inner surface 22 and inner surface 24 may each include a separate identification assembly 14.

Identification assembly 14 includes a plurality of expandable and collapsible button assemblies 26, which may also be referred to as expandable and collapsible assemblies 26, button assemblies 26, or socket assemblies 26. Expandable and collapsible assemblies 26 may be any suitable assembly capable of extending from a first collapsed position to a second expanded position. Exemplary expandable and collapsible assemblies 26 include the socket assemblies 26 depicted in the Figures, and other bellows-type configurations. Bellows-type configurations may be of a telescoping configuration.

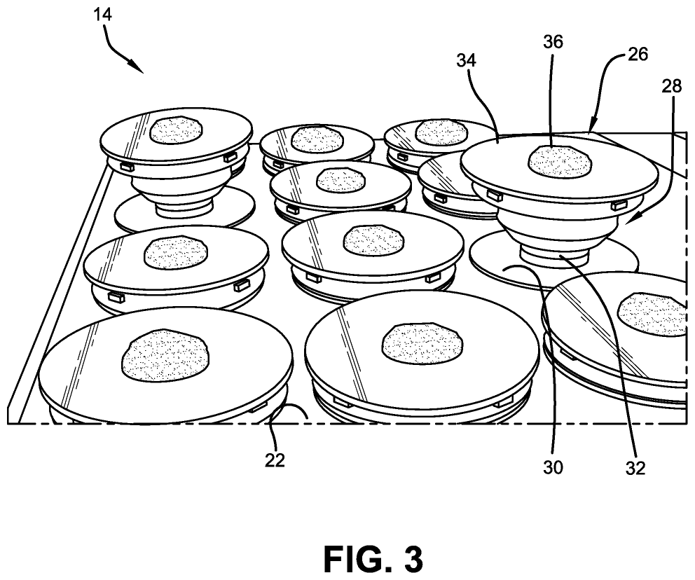

With further reference to FIGS. 1-8, expandable and collapsible socket assemblies 26 are shown. Socket assemblies 26 are capable of extending from a first collapsed position (FIG. 1) to a second expanded position (FIG. 3) by way of an extendable component 28. Extendable component 28 is coupled with a base 30 by way of a securing component 32. Base 30 may be secured with inner surface 22 or inner surface 24 by way of a suitable adhesive (not seen). In other embodiments, base 30 may be unitary with inner surface 22 or inner surface 24, such as by a manufacturing method where base 30 and inner surface 22 or inner surface 24 are molded together.

Securing component 32 may include extendable component 28 having a distal end portion that is wider than an inner portion of base 30. The wider portion of extendable component 28 serves to allow the extendable component 28 to be extended to the extended position while also preventing extendable component 28 from being pulled from base 30. Securing component 32 may be snap-fit within base 30 or may be of a configuration that allows for locking and unlocking extendable component 28 with respect to base 30.

Socket assemblies 26 include a button 34 at the end of extendable component 28 opposing base 30. Button 34 may have a diameter approximating the diameter of base 30, though other dimensions may be suitable. Button 34 generally serves to allow for a user to grasp button 34 to extend extendable component 28 and to push or grasp button 34 to collapse extendable component 28. Button 34 and base 30 are shown as being circular shaped, though other shapes such as rectangles may be suitable.

Button 34, specifically a top surface thereof, carries a releasable fastener 36. Releasable fastener 36 may be in the shape of a circle, though other shapes may be suitable. Releasable fastener 36 may be centrally located on the top surface of button 34. Releasable fastener 36 may be about ½ inch diameter, in other embodiments, about ¼ inch diameter, and in other embodiments, about ¾ inch diameter.

Releasable fastener 36 generally serves to receive a respective releasable fastener 38 positioned on a bottom surface 40 of an identification icon (e.g. identification icon 42A). As shown in the Figures, releasable fastener 36 and releasable fastener 38 may be respective components of a hook-and-loop fastener (e.g. Velcro® brand). In other embodiments, releasable fastener 36 and releasable fastener 38 may be magnetic components or a removable pressure-sensitive adhesive.

In one or more embodiments, releasable fastener 36 and a separate identification icon may not be present and the top surface of button 34 itself may include a respective identification icon integral therewith. That is, rather than including releasable fastener 36 and receiving an identification icon (e.g. identification icon 42A), the top surface of button 34 might include a color or letter or other identification.

In one or more embodiments, socket assemblies 26 (i.e. base 30 and button 34) may be about 1 inch diameter, in other embodiments, about 1.5 inches diameter, and in other embodiments, about 2 inch diameter. In one or more embodiments, socket assemblies 26 (i.e. base 30 and button 34) may be from ¾ inches to 2.5 inches diameter, in other embodiments, from 1 inch to 2 inches diameter, and in other embodiments, from 1 inch to 1.5 inches diameter.

In one or more embodiments, socket assemblies 26 may have a collapsed height of about ⅛ inches, in other embodiments, about ¼ inches, and in other embodiments, about ½ inches. In one or more embodiments, socket assemblies 26 may have a collapsed height of from ⅛ inches to ¾ inches, in other embodiments, from ⅛ inches to ½ inches, and in other embodiments, from ¼ inches to ½ inches.

In one or more embodiments, socket assemblies 26 may have an expanded height of about ¾ inches, in other embodiments, about 1 inch, and in other embodiments, about 1.5 inches. In one or more embodiments, socket assemblies 26 may have an expanded height of from ¾ inches to 1.5 inches, in other embodiments, from ¾ inches to 1 inch, and in other embodiments, from 1 inch to 1.5 inches.

In one or more embodiments, socket assemblies 26 may be extendable to a first half position prior to extending to the full extended position. In one or more embodiments, socket assemblies 26 may have a half-expanded height of about ½ inches, in other embodiments, about ¾ inches, and in other embodiments, a range from ½ inches to ¾ inches.

Other suitable socket assemblies 26 or aspects of socket assemblies 26 may be generally known to the skilled person. U.S. Pat. Nos. 8,560,031; 10,463,116; and 10,655,775 are each incorporated herein by reference for this purpose.

As further description of the overall identification assembly 14, identification assembly 14 should include socket assemblies 26 being arranged in an aesthetically pleasing manner.

As shown in FIGS. 1-5, socket assemblies 26 may be arranged in a grid-type configuration. In one or more embodiments, arranging socket assemblies 26 in a grid-type configuration includes all of socket assemblies 26 being spaced equidistant from the nearest socket assemblies 26. This may also be referred to as a rectangular arrangement. The grid-type arrangement may also be referred to as respective socket assemblies 26 in nearby rows being aligned with each other.

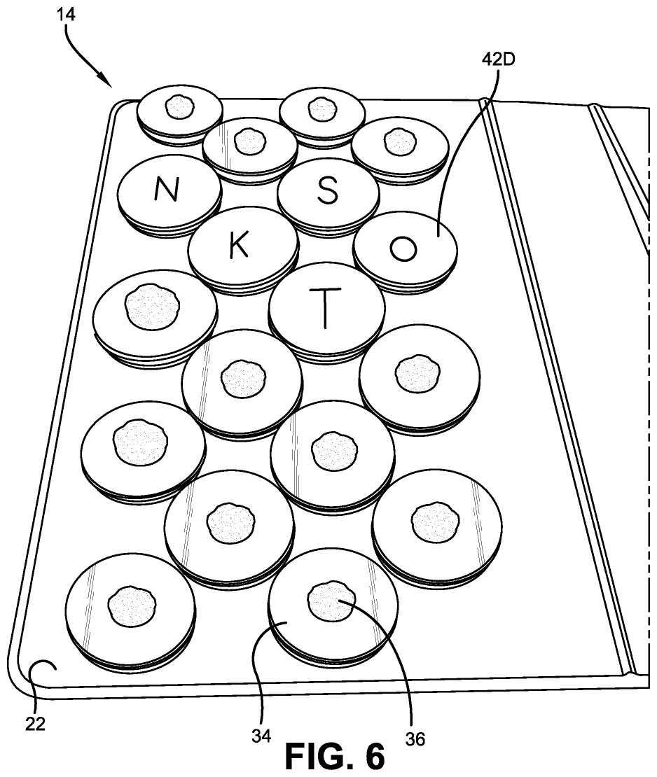

As shown in FIG. 6, socket assemblies 26 may be arranged in a honeycomb-type configuration. The honeycomb-type arrangement may also be referred to as respective socket assemblies 26 in the nearest row being offset with each other, and the respective socket assemblies 26 spaced two rows apart being aligned with each other.

In one or more embodiments, socket assemblies 26 may be arranged in another shape configuration, such as an oval or a circle.

As shown in the Figures, in one or more embodiments, all of the socket assemblies 26 are in the same configuration arrangement. In one or more embodiments, some of the socket assemblies 26 may be in a first type of configuration arrangement and other socket assemblies 26 may be in a second type of configuration arrangement.

Identification assembly 14 can include any suitable number of individual socket assemblies 26. In one or more embodiments, identification assembly 14 includes socket assemblies 26 arranged in 7 rows, in other embodiments, 6 rows, in other embodiments, 5 rows, in other embodiments, 4 rows, in other embodiments, 3 rows, and in other embodiments, 2 rows. In one or more embodiments, identification assembly 14 includes socket assemblies 26 arranged in 7 socket assemblies 26 per row, in other embodiments, 6 socket assemblies 26 per row, in other embodiments, 5 socket assemblies 26 per row, in other embodiments, 4 socket assemblies 26 per row, and in other embodiments, 3 socket assemblies 26 per row. In one or more embodiments, identification assembly 14 includes socket assemblies 26 arranged in 7 rows of 5 socket assemblies 26 per row, in other embodiments, 6 rows of 4 socket assemblies 26 per row, and in other embodiments, 5 rows of 3 socket assemblies 26 per row.

In one or more embodiments, all of the socket assemblies 26 within identification assembly 14 include a respective releasable fastener 36. In other embodiments, certain of the socket assemblies 26 within identification assembly 14 include a respective releasable fastener 36 and other of the socket assemblies 26 within identification assembly 14 do not include a respective releasable fastener 36.

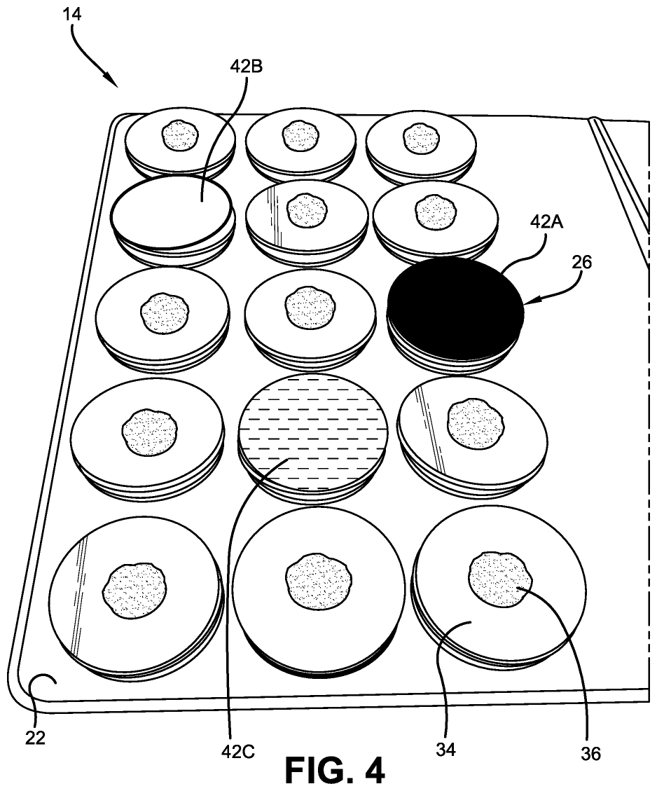

With further reference to FIG. 4, identification assembly 14 is shown with a variety of identification icons being positioned on respective socket assemblies 26. Specifically, identification assembly 14 includes a first color identification icon 42A, a second color identification icon 42B, and a third color identification icon 42C. The releasable fasteners 38 of the identification icons 42A, 42B, 42C are fastened with respective releasable fasteners 36 of socket assemblies 26. Though only three identification icons are shown in FIG. 4, as suggested above, one or more embodiments may include all of the socket assemblies 26 carrying a respective identification icon.

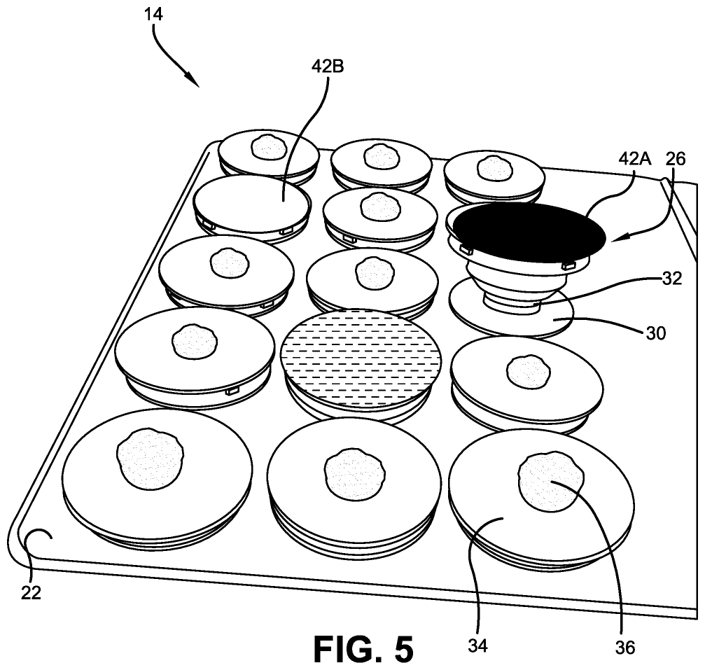

In this configuration of identification assembly 14 including a plurality of identification icons, which may be referred to as an in-use configuration, sensory educational assembly 10 can be utilized by an instructor with a student-user. The instructor can ask the user to identify which of the identification icons has the color of the first color identification icon 42A. The user of sensory educational assembly 10 can then demonstrate recognition of the instructed identification icon by expanding the respective socket assembly 26. In this example, FIG. 5 shows a configuration where the user has correctly demonstrated recognition of the instructed identification icon of first color identification icon 42A. The socket assembly 26 carrying first color identification icon 42A has been raised in FIG. 5. The ability of socket assemblies 26 to be expanded and collapsed provides the user with sensory input and the user can come to associate that sensory input with having selected the correct response.

If, in FIG. 5, the user had been instructed to identify the identification icon of second color identification icon 42B, then this configuration of FIG. 5 shows that the user has incorrectly demonstrated recognition of the instructed identification icon. The instructor can then collapse the socket assembly 26 carrying first color identification icon 42A and offer further instruction to assist the user with identifying the socket assembly 26 carrying second color identification icon 42B.

In a similar but reverse manner, a plurality of the socket assemblies 26 up to all of the socket assemblies 26 might be first placed in the expanded position by the instructor. The instructor can then ask the user to identify a certain identification icon by collapsing the respective socket assembly 26. For example, if, in FIG. 5, the user had been instructed to identify the identification icon of second color identification icon 42B and third color identification icon 42C, then this configuration of FIG. 5 shows that the user has correctly demonstrated recognition of the instructed identification icons.

In addition to the colors of identification icons 42A, 42B, 42C, other representations may be utilized. For example, with reference to FIG. 6, identification icons 42D may include a variety of letters. Lettered identification icons 42D may be used in the above-described identification technique. Lettered identification icons 42D may also be used for spelling instructions and other similar instructions. Other suitable representations for identification icons include numbers, full words, and pictures of objects (e.g. animals).

Where identification icons 42A, 42B, 42C include full colors, the colors may be selected in order to stand out from the color of storage assembly 12. That is, all of the colors of the identification icons may be a different color from the color of storage assembly 12. This difference in colors might also be applied to the background color of the identification icons where a letter or other image is present. In other embodiments, one or more of the identification icons (whether full color or background color) may be the same color as the color of storage assembly 12.

The identification icons (e.g. identification icon 42A) can be made from any suitable material. Exemplary materials include laminated paper, construction paper, cardboard, plastic, and metal.

As suggested above, the identification icons can be configured to accomplish a variety of instructional tasks as well as otherwise useful tasks. Examples include academic tasks, object differentiation, task chains, macro-scheduling, micro-scheduling, sentence formation, and vocabulary. For example, for a task chain, the user may expand or collapse a specific socket assembly 26 once a task (e.g. chore) that has completed. Similarly, for scheduling purposes, the user may expand or collapse a specific socket assembly 26 once a timeframe (e.g. Monday) has passed.

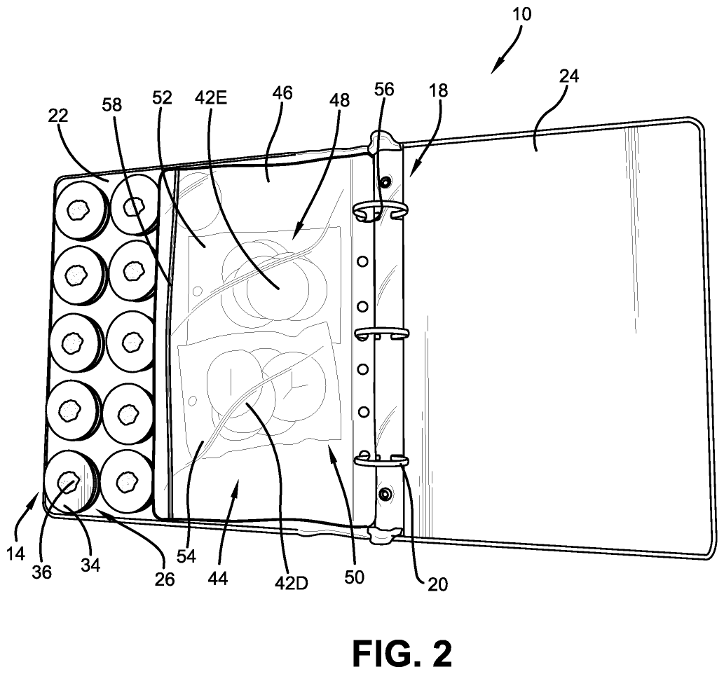

As shown in FIGS. 1 and 2, the identification icons 42D, 42E can be provided as part of an icon assembly 44. Icon assembly 44 includes an overall storage bag 46 that includes sub-storage assemblies 48, 50. Though two sub-storage assemblies 48, 50 are shown, other amounts may be utilized, such as one or more. Sub-storage assembly 48 includes a bag 52 and a first plurality of identification icons 42E. Sub-storage assembly 50 includes a bag 54 and a second plurality of identification icons 42D. In one or more embodiments, icon assembly 44 includes only one sub-storage bag, and in other embodiments, three or more sub-storage bags.

Overall storage bag 46 may include holes 56 corresponding with rings 20 for retaining overall storage bag 46 within storage assembly 12. In other embodiments, overall storage bag 46 may be provided separately from storage assembly 12. Overall storage bag 46 may further include a closure mechanism 58, such as a zipper 58, for retaining all sub-components within storage bag 46. Overall storage bag 46 may be made from plastic, such as polypropylene.

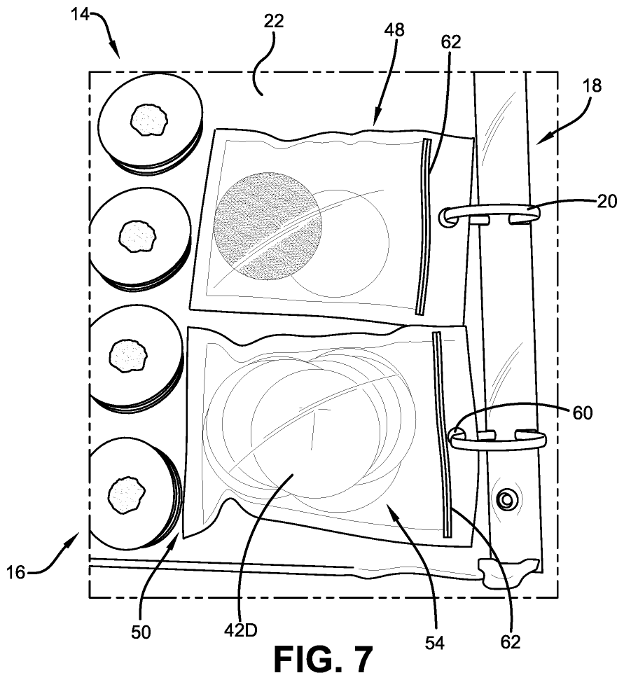

As shown in FIG. 7, in other embodiments, sub-storage assembly 48, 50 may be provided without overall storage bag 46. Sub-storage assembly 48, 50 may include a hole 60 corresponding with rings 20 for retaining sub-storage assembly 48, 50 within storage assembly 12. In other embodiments, sub-storage assembly 48, 50 may be provided separately from storage assembly 12. Sub-storage assembly 48, 50 may further include a closure mechanism 62, such as a zipper, for retaining the identification icons (e.g. identification icon 42D) within the bag (e.g. bag 54) of sub-storage assembly 48, 50. Sub-storage assembly 48, 50 may be made from plastic, such as polypropylene.

Sensory educational assembly 10 may further include a diagnosis tool for recording the results of the user input of sensory educational assembly 10. The diagnosis tool may be a program sheet. The diagnosis tool may include holes corresponding with rings 20 for retaining the diagnosis tool within storage assembly 12. In one or more embodiments, the diagnosis tool may be provided in a pocket (not shown) of inner surface 22 or inner surface 24 of storage assembly 12. In one or more embodiments, the diagnosis tool may be provided in overall storage bag 46.

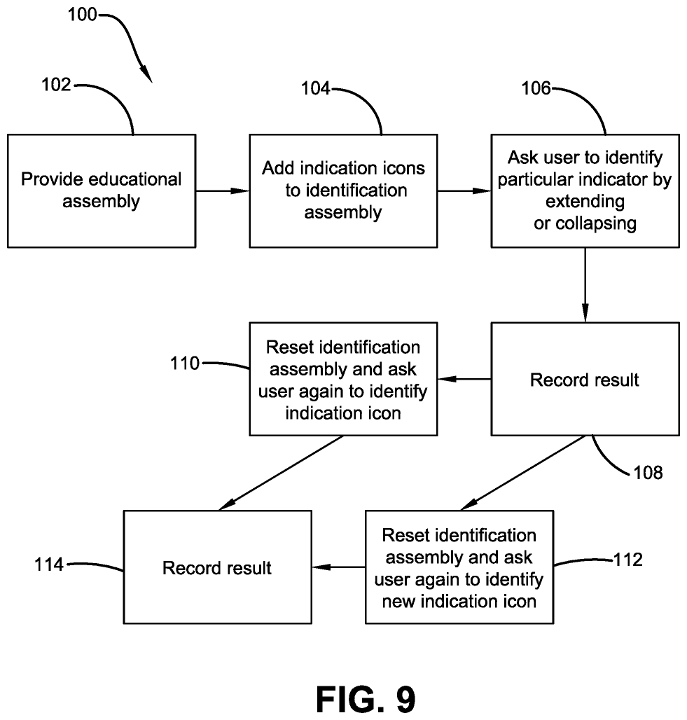

Though aspects of a method of utilizing the sensory educational assembly 10 have been discussed above, specific reference is now made to FIG. 9, which shows an educational method 100. Educational method 100 includes a first step 102 of providing the sensory educational assembly 10 discussed above. Following providing step 102, a step 104 can include adding the desired indications icons to the identification assembly. Next, in step 106 an instructor will ask a user to identify a particular indicator by extending or collapsing a button assembly. The result of the user in step 106 can be recorded in recording step 108. If the user is unsuccessful in step 106, step 110 can include the instructor resetting the identification assembly and asking the user again to identify the same indication icon from step 106. This may include further instruction. If the user is successful in step 106, step 112 can include the instructor resetting the identification assembly and asking the user to identify a different indication icon than the one from step 106. The result of the user in step 110 or step 112 can be recorded in recording step 114.

In light of the foregoing, it should be appreciated that the present invention advances the art by providing an improved sensory educational assembly. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A sensory educational assembly comprising
a storage assembly;
an identification assembly carried by the storage assembly and including
a plurality of expandable and collapsible button assemblies capable of extending from a first collapsed position to a second expanded position;
the expandable and collapsible button assemblies of the plurality of expandable and collapsible button assemblies including a releasable fastener on a top surface thereof; and
a plurality of identification icons having a respective releasable fastener on a bottom surface thereof;
such that the plurality of identification icons having the respective releasable fastener are capable of fastening with the releasable fasteners of the expandable and collapsible button assemblies to thereby provide the expandable and collapsible button assemblies with the plurality of identification icons in an in-use configuration of the sensory educational assembly.

2. The sensory educational assembly of claim 1, wherein the storage assembly is a ring binder having a front cover providing a front inner surface and a back cover providing a back inner surface.

3. The sensory educational assembly of claim 2, wherein the identification assembly is positioned on the front inner surface.

4. The sensory educational assembly of claim 3, wherein the identification assembly is positioned on only the front inner surface such that the back inner surface is devoid of an identification assembly.

5. The sensory educational assembly of claim 3, wherein a second identification assembly is positioned on the back inner surface.

6. The sensory educational assembly of claim 1, wherein the plurality of expandable and collapsible button assemblies are arranged in a grid-type arrangement.

7. The sensory educational assembly of claim 6, wherein all of the plurality of expandable and collapsible button assemblies are spaced equidistant from each other relative to a nearest respective one of the plurality of expandable and collapsible button assemblies.

8. The sensory educational assembly of claim 1, wherein the plurality of expandable and collapsible button assemblies are arranged in a honeycomb-type arrangement.

9. The sensory educational assembly of claim 1, wherein the plurality of identification icons include a plurality of colors.

10. The sensory educational assembly of claim 1, wherein the plurality of identification icons include a plurality of letters.

11. The sensory educational assembly of claim 1, each of the plurality of expandable and collapsible button assemblies including an extendable component coupled with a base.

12. The sensory educational assembly of claim 11, wherein the extendable component carries a button defining the top surface, the button positioned at an end of the extendable component opposing the base.

13. The sensory educational assembly of claim 12, wherein a diameter of the button approximates a diameter of the base.

14. The sensory educational assembly of claim 11, wherein the extendable component is snap-fit with the base.

15. A sensory educational assembly kit comprising
a storage assembly;
an identification assembly carried by the storage assembly and including
a plurality of expandable and collapsible button assemblies capable of extending from a first collapsed position to a second expanded position;
the expandable and collapsible button assemblies of the plurality of expandable and collapsible button assemblies including a releasable fastener on a top surface thereof;
an overall storage bag including
a first sub-storage assembly with a first plurality of identification icons having a respective first releasable fastener on a bottom surface thereof;
a second sub-storage assembly with a second plurality of identification icons having a respective second releasable fastener on a bottom surface thereof;
such that the first plurality of identification icons having the respective first releasable fastener and the second plurality of identification icons having the respective second releasable fastener are capable of fastening with the releasable fasteners of the expandable and collapsible button assemblies to thereby provide the expandable and collapsible button assemblies with the plurality of identification icons in an in-use configuration of the sensory educational assembly.

16. The sensory educational assembly kit of claim 15, wherein the storage assembly is a ring binder having a front cover providing a front inner surface and a back cover providing a back inner surface, wherein the identification assembly is positioned on the front inner surface.

17. The sensory educational assembly kit of claim 15, wherein the first plurality of identification icons include a plurality of colors, and wherein the second plurality of identification icons include a plurality of letters.

18. A sensory educational assembly comprising
a storage assembly;
an identification assembly carried by the storage assembly and including
a plurality of expandable and collapsible button assemblies capable of extending from a first collapsed position to a second expanded position;
the expandable and collapsible button assemblies of the plurality of expandable and collapsible button assemblies including a releasable fastener on a top surface thereof;
a plurality of identification icons having a respective releasable fastener on a bottom surface thereof;
the plurality of identification icons being fastened with respective ones of the plurality of expandable and collapsible button assemblies;
wherein at least one of the plurality of expandable and collapsible button assemblies is in the first collapsed position, and wherein at least one of the plurality of expandable and collapsible button assemblies is in the second expanded position.

19. The sensory educational assembly kit of claim 18, wherein the storage assembly is a ring binder having a front cover providing a front inner surface and a back cover providing a back inner surface, wherein the identification assembly is positioned on the front inner surface.

20. The sensory educational assembly of claim 18, each of the plurality of expandable and collapsible button assemblies including an extendable component coupled with a base, wherein the extendable component carries a button defining the top surface, the button positioned at an end of the extendable component opposing the base, wherein the extendable component is snap-fit with the base.
